(19) United States
(12) Patent Application Publication
(10) Pub. No.: US 2026/0119240 A1
(43) Pub. Date: Apr. 30, 2026

(54) TRAFFIC ROUTING BASED ON CARBON EMISSION INFORMATION

(71) Applicant: Hewlett Packard Enterprise Development LP, Spring, TX (US)

(72) Inventors: Supriya Kamthania, Bangalore (IN); Sonu Sudhakaran, Bangalore (IN); Arun Mahendran, Bangalore (IN)

(21) Appl. No.: 19/039,055

(22) Filed: Jan. 28, 2025

(30) Foreign Application Priority Data
Oct. 29, 2024 (IN) 202441082566

(51) Int. Cl. G06F 9/48; G06F 9/50

(52) U.S. Cl. CPC G06F 9/4893; G06F 9/5094; G06F 2209/505

(57) ABSTRACT

In some examples, workloads are executed at virtual schedulable entities across a cluster of computing nodes. A system receives, for the cluster, carbon emission information and metric data for the workloads. Based on the carbon emission information and power consumption information derived from the metric data of the workloads, the system adjusts a routing policy for routing of traffic associated with the workloads. The system sends the adjusted routing policy to a traffic router of the cluster of computing nodes, the traffic router to use the adjusted routing policy in routing traffic for the workloads in the cluster of computing nodes.

### BACKGROUND

A cluster of computing nodes can be used to execute workloads. Workloads may be distributed across computing nodes to balance the loads of the computing nodes in the cluster.

### BRIEF DESCRIPTION OF THE DRAWINGS

Some implementations of the present disclosure are described with respect to the following figures.

FIG. 1 is a block diagram of an arrangement including clusters of computing nodes and a cluster management system according to some examples.

FIG. 2 is a flow diagram of a process of a traffic routing controller according to some examples.

FIG. 3 is a flow diagram of a process of a workload scheduler according to some examples.

FIG. 4 is a block diagram of a storage medium storing machine-readable instructions according to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A service provider can deploy a platform that supports clusters of computing nodes at different geographic locations. Each cluster of computing nodes can be used by tenants (customers) of the service provider. In some cases, different tenants are assigned different respective clusters of computing nodes. In other cases, different tenants may share a cluster of computing nodes. In some examples, the clusters can include Kubernetes clusters. In other examples, other types of clusters of computing nodes can be employed, such as a Docker cluster. A cluster of computing nodes can execute workloads using virtual schedulable entities, such as containers, pods (where a pod can include one or more containers), or virtual machines (VMs). A workload executed in a container can be referred to as a “containerized workload.”

Environmental impacts associated with executing workloads on computing nodes of a cluster include carbon emissions and energy consumption. If environmental sustainability metrics (relating to carbon emissions and energy consumption) are not considered in routing traffic and placing workloads in one or more clusters of computing nodes, the workloads may cause elevated carbon emissions. In addition, overprovisioning computing nodes for workloads (in which too many resources are allocated to the workloads) can lead to wasteful energy consumption, especially during periods of low demand. In addition, some jurisdictions may have carbon emission regulations which if violated can result in penalties to an operator. Additionally, lack of insight into energy patterns of workloads can result in a large concentration of energy-intensive activities on some computing nodes, which can lead to energy consumption spikes and thus increased carbon emissions.

In accordance with some implementations of the present disclosure, a workload management system for one or more clusters of computing nodes can control traffic routing among workloads executed at virtual schedulable entities in the cluster(s) of computing nodes. The traffic routing control is performed by adjusting a routing policy based on carbon emission information, metric data for the workloads, and other information. The adjusted routing policy is sent by the workload management system to a traffic router of a cluster of computing nodes, and the traffic router uses the adjusted routing policy in routing traffic for the workloads in the cluster of computing nodes to achieve reduced carbon emissions. In addition to routing traffic to workloads of the cluster, the traffic router can also route traffic to workloads of other clusters of computing nodes.

In further examples, a workload scheduler can also place workloads in computing nodes that consider sustainability goals, including reducing carbon emissions and promoting energy efficiency.

By performing carbon-aware adjustments of traffic routing policies and workload placements, organizations can achieve sustainability goals that comply with government regulations as well as internal goals of the organizations. Carbon emissions can be achieved while still meeting performance goals of workloads. Also, the carbon-aware adjustments of traffic routing policies and workload placements can result in more efficient power usage, which can reduce costs for organizations.

A “workload” can refer to a collection of activities of a microservice, an application program, a machine, or any other entity. A “virtual schedulable entity” that can perform a workload can refer to a container, a pod including one or more containers, or a virtual machine (VM). “Traffic” of workloads that can be routed according to the adjusted routing policy can include a request to perform an action by a workload, or data to be consumed or processed by a workload, or data to be transmitted from a source to a workload. A request can include a network request, such as a Hypertext Transfer Protocol (HTTP) request, a call of an application programming interface (API), or any other message or information element that can be sent from one entity to another entity. Data can include data stored in a storage system, data of a database, data generated by a program, or any other type of data.

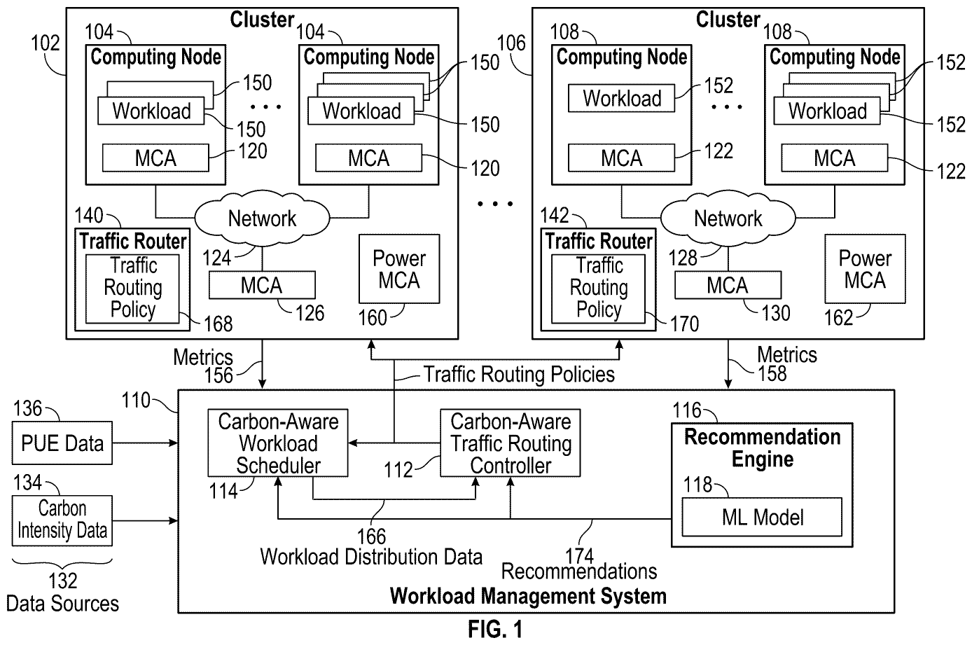

FIG. 1 is a block diagram of an example arrangement that includes multiple clusters of computing nodes. The example shown includes a cluster 102 of computing nodes 104, and another cluster 106 of computing nodes 108. Although two clusters 102 and 106 are shown in FIG. 1, in other examples, just a single cluster of computing nodes may be present in a system, or more than two clusters of computing nodes may be present in the system.

A cluster of computing nodes can include computing nodes of one or more computing environments, such as a data center, a cloud environment, a server farm, or any other type of computing environment. The computing nodes of a cluster can be located generally in one geographic region, or the computing nodes may be dispersed across different geographic regions, such as different facilities within a city, different cities or states, different countries, or other geographic regions. For example, a cluster can include multiple data centers in different cities.

The example arrangement further includes a workload management system 110 that performs workload management for clusters of computing nodes, including the clusters 102 and 106. The workload management system 110 includes a carbon-aware traffic routing controller 112 (hereinafter simply referred to as “traffic routing controller 112”) and a carbon-aware workload scheduler 114 (hereinafter simply referred to as “workload scheduler 114”) according to some examples. Although shown as two separate entities, in other examples, the traffic routing controller 112 and the workload scheduler 114 can be integrated into one controller. The traffic routing controller can control routing of traffic associated with workloads based on factors that consider carbon emissions. Similarly, the workload scheduler 114 that places workloads on computing nodes of the clusters 102 and 106 based on factors that consider carbon emissions. Placing a workload can refer to moving a workload from one computing node to another computing node (within the same cluster or in different clusters), or scheduling a new workload for execution on a selected computing node.

In some examples, the workload management system 110 also includes a recommendation engine 116 that executes a machine learning (ML) model 118 to make predictions regarding time intervals in which carbon emissions are expected to be lower than other time intervals.

As depicted in FIG. 1, workloads 150 are executed in the computing nodes 104 of the cluster 102, and workloads 152 are executed in the computing nodes 108 of the cluster 106. The workloads 150 and 152 can be performed by virtual schedulable entities such as containers or VMs. The placement of the workloads 150 and 152 on respective computing nodes 104 and 108 is controlled by the workload scheduler 114.

Each computing node includes a metric collector agent (MCA). For example, the computing nodes 104 include respective MCAs 120, and the computing nodes 108 of the cluster 106 include respective MCAs 122. An MCA can refer to a collection of sensors used to collect metrics relating to operations in a cluster. A “collection” of items can refer to a single item or multiple items. Thus, a collection of sensors can refer to a single sensor or multiple sensors. A “sensor” can refer to a hardware sensor or a software sensor.

The computing nodes 104 of the cluster 102 can communicate over a network 124, which can be a local area network (LAN), a wide area network (WAN), or a different type of network. An MCA 126 is associated with the network 124 to collect metrics associated with traffic communications over the network 124. Similarly, the computing nodes 108 of the cluster 106 communicate over a network 128. An MCA 130 is associated with the network 128 to collect metrics associated with traffic communications over the network 128.

Each cluster also includes a power MCA to collect information about power consumption by the cluster, or by subsets of computing nodes in the cluster. The cluster 102 includes a power MCA 160 to collect a power consumption metric relating to power usage by the cluster 102, or by subsets of the computing nodes 104 in the cluster 102. A subset of computing nodes can include a single computing node or multiple computing nodes. Similarly, the cluster 102 includes a power MCA 162 to collect a power consumption metric relating to power usage by the cluster 106, or by subsets of the computing nodes 108 in the cluster 106. A power MCA can include a metered power distribution unit (PDU), a smart power strip, or any other power monitoring component that can measure electrical current or power.

Each MCA can send collected metrics to the workload management system 110. For example, the MCAs 120, 126, and 160 in the cluster 102 can send metrics 156 to the workload management system 110. Similarly, the MCAs 122, 130, and 162 in the cluster 106 can send metrics 158 to the workload management system 110.

The traffic routing controller 112 and workload scheduler 114 can perform their respective operations based on the metrics 156 and 158 from the clusters 102 and 106. The traffic routing controller 112 and workload scheduler 114 also consider data from various data sources 132 (that are different from metrics collected by the MCAs in the clusters). The data sources 132 may include external data sources accessible over a public network, such as the Internet. In other examples, the data sources 132 may be produced based on sensors in the clusters 102 and 106.

The data sources 132 include carbon intensity data 134 that specifies carbon emissions as a function of energy used. The carbon intensity data 134 may differ for different geographic regions. For example, a first geographic region may have a higher carbon intensity than a second geographic region. The difference in carbon intensities may be due to differences in types of energy sources used in the respective geographic regions. The first geographic region may use renewable energy sources such as wind turbines or solar panels. The second geographic region may include hydrocarbon power plants. More generally, different sites may have different carbon intensities. A “site” can include a computing environment (e.g., a data center, a cloud environment, etc.), a geographic region, a cluster, or any other site.

In further examples, a difference in carbon intensities for different sites may be due to different uses of carbon offsets. A carbon offset refers to a technique in which a power generator (e.g., a utility company, an energy seller, etc.) compensates for carbon emissions by investing in other projects that reduce carbon emissions. A first power generator in a first site may have invested in a first carbon offset that is different from a second carbon offset invested by a second power generator in a second site.

The data sources 132 may also include power efficiency data, such as in the form of power usage effectiveness (PUE) data for a computing environment. The PUE of a computing environment is based on a ratio of the total amount of energy used by the computing environment to the energy input to the computing environment. A higher PUE value indicates less efficiency, while a PUE value of 1 indicates the highest efficiency. In other examples, other power efficiency parameters for representing the power efficiency a computing environment may be employed. Different computing environments (such as different data centers or other computing environments) may have different PUEs, with some computing environments more efficient than other computing environments. The PUE of a computing environment may be monitored using power consumption metrics relative to power input to the computing environment.

Each cluster of computing nodes further includes a respective traffic router. For example, the cluster 102 includes a traffic router 140, and the cluster 106 includes a traffic router 142. Although just one traffic router is depicted in each cluster, in other examples, a cluster may include more than one traffic router.

A traffic router can refer generally to an entity that routes traffic (e.g., requests and/or data) to one or more target entities. A target entity can include a collection of virtual schedulable entities (a single virtual schedulable entity or multiple virtual schedulable entities). A request routed to a virtual schedulable entity can cause the virtual schedulable entity to perform a requested operation. Data routed to a virtual schedulable entity can cause a workload performed in the virtual schedulable entity to process the data. A target entity to which traffic is routed can also include a computing node. As another example, a target entity to which traffic is routed can include a different cluster.

The traffic routing controller 112 receives one or more of the following pieces of information: the metrics 156 and 158 from the clusters 102 and 106, respectively; the carbon intensity data 134, the PUE data 136, or workload distribution data 166 indicating which workloads are placed on which computing nodes. The workload distribution data 166 can be provided by the workload scheduler 114 to the traffic routing controller 112 based on placements of workloads on computing nodes of the clusters 102 and 106 performed by the workload scheduler 114.

The traffic routing policies produced by the traffic routing controller 112 are provided to the traffic routers 140 and 142. For example, the traffic routing controller 112 can send a traffic routing policy 168 to the traffic router 140, which stores the traffic routing policy 168 in a memory of the traffic router 140. Similarly, the traffic routing controller 112 can send a traffic routing policy 170 to the traffic router 142, which stores the traffic routing policy 170 in a memory of the traffic router 142.

In some examples, a traffic routing policy can be defined by a Kubernetes custom resource definition (CRD). In some examples, a CRD may be defined for a particular cluster (e.g., different clusters are assigned different CRDs). In other examples, a traffic routing policy may be included in a different type of data structure.

A traffic routing policy can include information that controls how traffic is to be routed. For example, traffic can be routed based on network addresses included in requests or data packets containing data. The network addresses can include Internet Protocol (IP) addresses that identify computing nodes or virtual schedulable entities. In other examples, a traffic routing policy can specify routing of traffic based on an identifier of a user, a group of users, a program, or a machine that the traffic is associated with. For example, the traffic routing policy can specify that traffic associated with a group of users is to be sent to workloads on specific computing node(s) of a given cluster.

Examples of the traffic router 140 or 142 can include any or some combination of the following: a network switch, an ingress controller, or a service mesh. The network switch is able to route requests and data based on network addresses; for example, a request or data packet with a source IP address and a destination IP address would be routed, based on routing information in the network switch, along a path to a target entity.

An example of the ingress controller is a Kubernetes ingress controller. The Kubernetes ingress controller can route a request, such as an HTTP request, based on one or more rules contained in a traffic routing policy. The rule(s) is (are) matched to an incoming request. The rule can specify that HTTP traffic for a given IP address and/or host is to be routed to one or more target entities. In examples where a traffic router is a Kubernetes ingress controller, a traffic routing policy used by the Kubernetes ingress controller includes an ingress resource.

An example of the service mesh is a Kubernetes service mesh, which controls service-to-service communications. The Kubernetes service mesh applies routing rule(s) in a traffic routing policy to direct traffic from one service (e.g., a first workload or other type of service) to another service.

The workload scheduler 114 places workloads on computing nodes of the clusters 102 and 106 based on the metrics 156, 158, the carbon intensity data 134, the PUE data 136, and the traffic routing policies from the traffic routing controller 112. Whereas the focus of the traffic routing policies generated by the traffic routing controller 112 is to manage the flow of requests and data of the clusters 102 and 106 in a manner that reduces carbon emissions, the focus of the workload scheduling performed by the workload scheduler 114 is to determine when and where to run workloads, based on resource availability and with the goals of achieving energy efficiency and carbon emission reduction. More generally, whereas traffic routing relates to dynamic traffic flow management between components, workload scheduling relates to strategic resource allocation and controlling the timing of executing workloads.

Considering the traffic routing policies when performing workload placement increases the likelihood that workloads are placed on computing nodes of the clusters 102 and 106 in alignment with where traffic would be routed. For example, when deciding where to place a new workload, the workload scheduler 114 can consider, based on a traffic routing policy from the traffic routing controller 112, where traffic is more likely to be routed. The workload scheduler 114 can then place the new workload at computing nodes that are consistent with routing according to the traffic routing policy.

The recommendation engine 116 can analyze various input information, including the metrics 156, 158, the carbon intensity data 134, the PUE data 136, and information regarding workloads to predict time intervals when carbon emissions can be reduced. The ML model 118 in the recommendation engine 116 can include a time series ML model that applies time series analysis to input information for developing patterns and trends relating to when more workloads are likely to run and when energy consumption and carbon emissions are higher. The input information can include historical information associated with operations of the clusters 102 and 106. The historical information can include metrics, carbon intensity data, PUE data, and other data.

An example of a time series ML model includes an autoregressive integrated moving average (ARIMA) model that uses past values to predict future values of a time series. Another example of a time series ML model is a long short-term memory (LSTM) model that can handle time series data with long-term dependencies. The LSTM model can capture complex patterns in time series data.

Recommendations 174 from the ML model 118 can include information of optimal time intervals for executing workloads or to migrate workloads from one computing node to another computing node (or from one cluster to another cluster). Other recommendations 174 from the ML model 118 can include information specifying adjustments in resource allocations to workloads (e.g., increase or decrease an allocation of CPU resources or memory resources). In an example, the ML model 118 can predict that the load (and carbon emissions) during identified time intervals is expected to be light on certain computing nodes or in certain clusters. The recommendation engine 116 can include, in the recommendations 174, information of the identified time intervals. The recommendations 174 are provided to the traffic routing controller 112 and the workload scheduler 114.

The workload scheduler 114 can defer scheduling of non-urgent workloads until the identified time intervals. The traffic routing controller 112 may route traffic to computing nodes with lighter loads during the identified time intervals.

### Traffic Routing

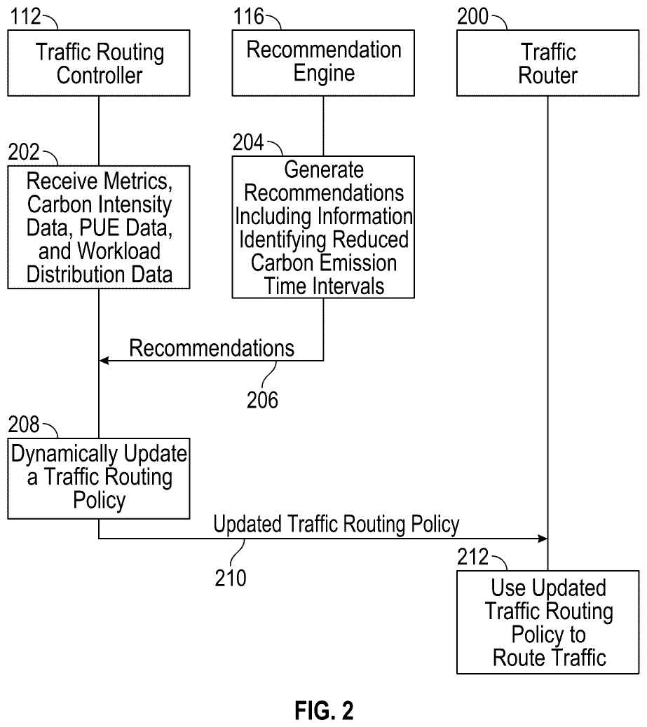

In some examples, as shown in FIG. 2, the traffic routing controller 112 can receive (at 202) the following information: the metrics 156, 158, the carbon intensity data 134, the PUE data 136, and the workload distribution data 166. The dynamic adjustment of traffic routes based on generating and applying traffic routing policies can be based on real-time metrics, such as those collected by the MCAs in the clusters 102 and 106. A “real-time metric” can refer to a metric collected during the operation of a cluster, where the metric is sent to a consumer of the metric (e.g., the traffic routing controller 112 and the workload scheduler 114) as the metric is collected.

The metrics may continually change due to changing conditions in the clusters 102 and 106. Other information may also change, including carbon intensities in the carbon intensity data 134 and PUEs in the PUE data 136. As a result, the traffic routing controller 112 can continually adjust traffic routing policies in response to the changing metrics, carbon intensities, and/or PUEs.

Examples of metrics collected by the MCAs 120 and 122 in the computing nodes 104 and 108 can include any or some combination of the following: a CPU utilization metric representing how many CPUs (or cores of CPUs) a collection of workloads is consuming, a memory utilization metric representing how much memory space is consumed by a collection of workloads, or a utilization metric relating to utilization of another physical resource of a computing node.

The power MCAs 160 and 162 can collect power consumption metrics that specify how much power (e.g., in terms of watts) is being consumed by a collection of workloads.

The traffic routing controller 112 can also consider workload patterns on computing nodes based on the workload distribution data 166 from the workload scheduler 114. The workload patterns may indicate that some computing nodes (or computing environments such as data centers) may be more heavily loaded than other computing nodes (or computing environments). The traffic routing controller 112 can adjust traffic routing policies to direct traffic away from the more heavily loaded computing nodes or computing environments.

The recommendation engine 116 also generates (at 204) recommendations that include information identifying time intervals of reduced carbon emissions. The recommendations are based on an output of the ML model 118. The recommendation engine 116 sends (at 206) the recommendations to the traffic routing controller 112.

Based on the received information and the recommendations, the traffic routing controller 112 dynamically updates (at 208) a traffic routing policy for a cluster of computing nodes to reduce carbon emissions while maintaining performance levels. Routing decisions consider factors such as carbon intensities (in the carbon intensity data 134), a workload distribution (in the workload distribution data 166), power efficiency parameters (in the PUE data 136), and the identified time intervals of reduced carbon emissions from the recommendation engine 116. Power consumption can be derived from the metrics. The product of the power consumption and the carbon intensity produces a carbon emission of the given cluster. For example, power consumptions of workloads, computing nodes, computing environments, or clusters can be determined. Each of the power consumptions can be multiplied by a respective carbon intensity to produce a carbon emission for a workload, a computing node, a computing environment, or a cluster.

The traffic routing controller 112 sends (at 210) the updated traffic routing policy to a traffic router (e.g., 140 or 142 in FIG. 1) of the cluster of computing nodes. The traffic router uses (at 212) the updated traffic routing policy in routing traffic to target entities.

The following describes a specific example of how the traffic routing controller 112 performs a routing decision based on example input information. Metrics received by the traffic routing controller 112 can indicate the following for a given cluster with computing nodes in region A and region B. The collected real-time metrics can indicate: CPU utilization of workloads in containers across all computing nodes of the given cluster is W % on average; memory utilization of workloads in containers across all computing nodes of the given cluster is X % on average; the amount of network data is Y gigabits per second (Gbps) on average; and Z MW/h (megawatt per hour) average power consumption in the given cluster.

The traffic routing controller 112 also receives the following carbon intensity data: 0.8 kgCO2 eq/kWh (carbon dioxide equivalent per kilowatt-hour) for region A; and 0.5 kgCO2 eq/kWh for region B.

The traffic routing controller 112 also receives recommendations from the recommendation engine 116 identifying which time intervals are high usage time intervals associated with increased carbon emissions.

A carbon-aware routing decision performed by the traffic routing controller 112 can adjust a traffic routing policy for the given cluster to route traffic to region B (with the lower carbon intensity as compared to region A) during identified high-usage time intervals.

Further, region B may have two data centers 1 and 2. Data center 1 may have a PUE of 1.2 and data center 2 may have a PUE of 1.5 (which indicates that data center 2 has a lower power efficiency than data center 1). The traffic routing policy generated by the traffic routing controller 112 can prioritize routing to data center 1 to reduce energy consumption.

Moreover, within data center 1, the workload distribution data can indicate that some computing nodes have more workloads than other workloads. The traffic routing policy generated by the traffic routing controller 112 can balance the workloads by routing traffic to computing nodes with a smaller quantity of workloads.

The traffic routing controller 112 continually monitors input information and adjusts routing decisions dynamically. For example, if the traffic routing controller 112 detects that the carbon intensities of a given region has dropped below a specified carbon intensity threshold (e.g., 0.4 kgCO2 eq/kWh), the traffic routing controller 112 may consolidate workloads to fewer computing nodes or data centers to increase energy efficiency.

### Workload Scheduling

The workload scheduler 114 can perform workload scheduling according to some examples of the present disclosure. In some examples, the workload scheduler 114 can also perform service provisioning. Workload scheduling refers to placing workloads on specific computing nodes in corresponding clusters, where the workloads may be executed by virtual schedulable entities.

Service provisioning can refer to the establishment and management of services within a cluster of computing nodes. The services are used by workloads. For example, some services may support communication between workloads. In some examples, the services are Kubernetes services that enable pods to interact with each other and with external entities. In other examples, other types of services are provisioned. During service provisioning, traffic routing policies that consider carbon emissions can be enforced to ensure that the deployment of the services aligns with sustainability goals. For example, the framework can prioritize routing traffic to services hosted in clusters that operate with lower carbon emissions or are powered by renewable energy sources. By integrating carbon-aware considerations into service provisioning, organizations can enhance their ability to manage workloads sustainably, ensuring that their infrastructure not only meets performance requirements but also contributes to reduced carbon footprints and compliance with environmental regulations.

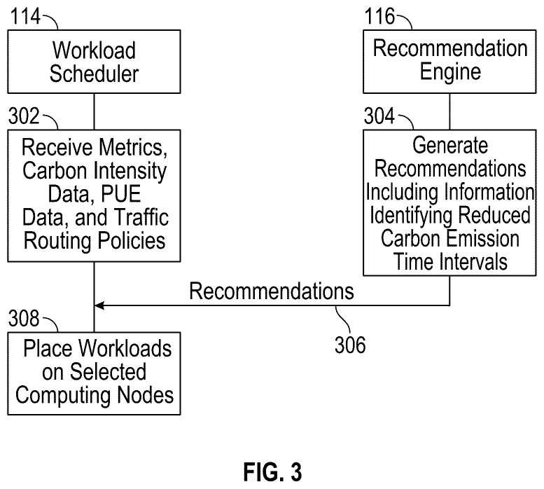

In some examples, as shown in FIG. 3, the workload scheduler 114 receives (at 302) the following information: the metrics 156, 158, the carbon intensity data 134, the PUE data 136, and traffic routing policies from the traffic routing controller 112.

The recommendation engine 116 also generates (at 304) recommendations that include information identifying time intervals of reduced carbon emissions. The recommendations are based on an output of the ML model 118. The recommendation engine 116 sends (at 306) the recommendations to the workload scheduler 114.

Based on the received information and the recommendations, the workload scheduler 114 places (at 308) workloads on selected computing nodes and provisions services for the workloads, to reduce carbon emissions while maintaining performance levels.

The following provides an example of workload placement based on input information received by the workload scheduler 114. The metrics from a given data center indicate that workload A uses 2 CPU cores and 4 GB (gigabytes) of memory, and that workload B uses 1 CPU core and 2 GB of memory. The carbon intensity for the given data center is 0.5 kgCO2/kWh.

The workload scheduler 114 calculates the following power consumptions for workloads A and B. For workload A, the power consumption due to CPU usage can be calculated as 2 CPU cores×50 W (watts)/core=100 W; and the power consumption due to memory usage can be calculated as 4 GB×20 W/GB=80 W. The total power consumed by workload A is 100 W+80 W=0.18 KW (kilowatts).

For workload B, the power consumption due to CPU usage can be calculated as 1 CPU core×50 W (watts)/core=50 W; and the power consumption due to memory usage can be calculated as 2 GB×20 W/GB=40 W. The total power consumed by workload A is 50 W+40 W=0.09 KW.

The workload scheduler 114 calculates the carbon emissions for workloads A and B. The carbon emission for a workload is based on the total power consumed by the workload multiplied by the carbon intensity. Thus, the carbon emission for workload A is 0.18 kW×0.5 kgCO2/kWh=0.09 kgCO2, and the emission for workload B is 0.09 KW×0.5 kgCO2/kWh=0.045 kgCO2.

In some cases, a carbon intensity of a data center (or another computing environment) may factor in a carbon offset. For example, the data center may be entitled to a 20% carbon offset, in which case the carbon intensity can be reduced by 20% (e.g., 0.5 kgCO2/kWh is reduced to 0.4 kgCO2/kWh).

In placing workloads, the workload scheduler 114 can move higher carbon emission workloads to a data center with a lower carbon intensity. Also, the workload scheduler 114 can schedule workloads to run during low usage time intervals, as identified in the recommendations from the recommendation engine 116. The workload scheduler 114 can also consolidate workloads to more energy-efficient data centers, such as based on the PUE data 136.

As noted above, the workload scheduler 114 also considers a traffic routing policy within a cluster when placing workloads. If the traffic routing policy from the traffic routing controller 112 indicates that traffic of a particular application or user is to be sent to data center 1 of multiple data centers, then the workload scheduler 114 can schedule workloads of the particular application or user on computing nodes of data center 1 (rather than in another data center).

### Further Examples

In further examples, the workload management system 110 can track carbon emissions after traffic routing policies have been adjusted by the traffic routing controller 112, and after placements of workloads by the workload scheduler 114. The workload management system 110 can assess if carbon emissions have been reduced based on the adjustment of traffic routing policies and/or placements of workloads. The workload management system 110 can send a result of the assessment (which can indicate whether carbon emission reduction was achieved), to an administrator or another target. The result of the assessment may be presented in a user interface (UI), such as a dashboard, or may be included in a log or in alerts. Alerts may provide notifications of any anomalies or deviations from sustainability goals.

The functions of the traffic routing controller 112 and the workload scheduler 114 may be performed in various stages of workload deployment or service provisioning. An initial configuration stage involves setting up a cluster of computing nodes (e.g., a Kubernetes cluster) and defining initial routing policies. Also, at the initial configuration stage, sustainability goals including carbon reduction goals may be defined.

A workload creation stage deploys workloads within the cluster. Also, the workload scheduler 114 and/or a traffic router can enforce a routing policy. The workload scheduler 114 can ensure that new workloads are scheduled in a way that aligns with carbon reduction goals, such as prioritizing placement of workloads on computing nodes with lower carbon emissions.

A service discovery and registration stage creates services, such as Kubernetes services, which are registered with the cluster. In this stage, the routing policy can be applied to determine which service instances should handle incoming traffic, favoring those in regions with lower carbon intensity.

A scaling operations stage can allocate additional resources or deallocate resources based on demands of workloads, which may change over time. The adjusted routing policy can be used in making scaling decisions. For example, more resources may be allocated in computing nodes that are more energy efficient or that produce less carbon emissions.

Other stages of workload scheduling and traffic routing determinations may be used in other examples.

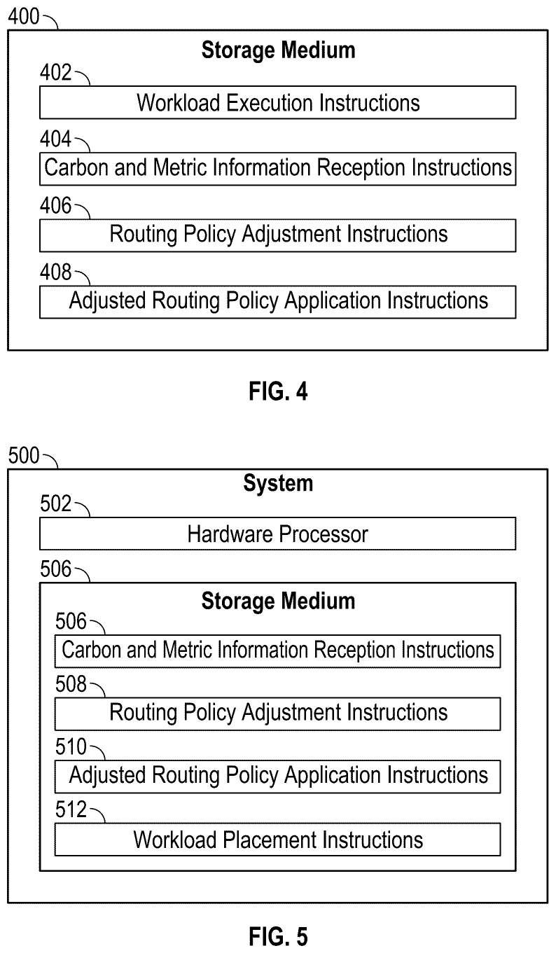

FIG. 4 is a block diagram of a non-transitory machine-readable or computer readable storage medium 400 storing machine-readable instructions that upon execution cause a system to perform various tasks. The system can include one or more computers.

The machine-readable instructions include workload execution instructions 402 to execute workloads at virtual schedulable entities across a cluster of computing nodes. Examples of virtual schedulable entities include containers, pods, or VMs.

The machine-readable instructions include carbon and metric information reception instructions 404 to receive, for the cluster, carbon emission information and metric data for the workloads. The carbon emission information can include a carbon intensity of a site, such as a computing environment (e.g., a data center, a cloud environment, etc.), a geographic region, a cluster, or any other site. Different sites may have different carbon intensities, such as due to use of different energy sources. Some sites may use energy from renewable energy sources while other sites use energy from hydrocarbon power generators. In further examples, the carbon emission information can include a carbon offset for each site.

The machine-readable instructions include routing policy adjustment instructions 406 to, based on the carbon emission information and power consumption information derived from the metric data of the workloads, adjust a routing policy for routing of traffic associated with the workloads. The power consumption information may be included in power consumption metrics, such as from the power MCAs 160 and 162 of FIG. 1. Alternatively, the power consumption information may be calculated from resource utilization metrics, such as CPU utilization metrics, memory utilization metrics, metrics relating to an amount of network data communicated, and so forth.

The machine-readable instructions include adjusted routing policy application instructions 408 to send the adjusted routing policy to a traffic router of the cluster of computing nodes. The traffic router uses the adjusted routing policy in routing traffic for the workloads in the cluster of computing nodes.

In some examples, the traffic routed according to the adjusted routing policy includes one or more of a request for a workload or data of the workload.

In some examples, the adjusted routing policy controls routing of the traffic to one or more of a container, a pod, a computing node, or a computing environment.

In some examples, the cluster of computing nodes is a first cluster of computing nodes, and the adjusted routing policy controls routing of further traffic between the first cluster of computing nodes and a second cluster of computing nodes based on the carbon emission information and the power consumption information.

In some examples, the metric data relates to one or more of processor utilization, memory utilization, or an amount of network data communication, and the power consumption information is based on the metric data relating to one or more of the processor utilization, the memory utilization, or the amount of network data communication.

In some examples, the carbon emission information includes a carbon intensity. The machine-readable instructions can compute a carbon emission of a workload of the workloads based on combining the carbon intensity and the power consumption information for the workload.

In some examples, the cluster of computing nodes is deployed across multiple sites, and the carbon emission information includes a first carbon intensity for a first site of the multiple sites, and a second carbon intensity for a second site of the multiple sites. The machine-readable instructions can compute a first carbon emission for the first site based on combining the first carbon intensity and the power consumption information, and compute a second carbon emission for the second site based on combining the second carbon intensity and the power consumption information. The adjusting of the routing policy is based on the first carbon emission and the second carbon emission. For example, the adjusted routing policy can favor routing of traffic to a site with a lower carbon emission.

In some examples, the machine-readable instructions can place a workload in the cluster of computing nodes based on the adjusted routing policy.

In some examples, the placing of the workload in the cluster of computing nodes is further based on resource utilization metrics of the computing nodes in the cluster of computing nodes. The workload may be placed on a computing node with a lower load, for example, to balance workloads across computing nodes.

In some examples, the machine-readable instructions can predict, based on historical information of carbon emissions and power consumption in the cluster of computing nodes, a first time interval with a lower carbon emission than a second time interval. The prediction may use a time-series ML model, for example. The machine-readable instructions can adjust the routing policy further based on the predicted first time interval.

In some examples, the traffic router includes one of a network switch, an ingress controller, or a service mesh.

In some examples, the machine-readable instructions can receive a power efficiency parameter (e.g., PUE) for the cluster. The adjusting of the routing policy is further based on the power efficiency parameter.

In some examples, the cluster of computing nodes is a first cluster of computing nodes. The machine-readable instructions can identify a second cluster of computing nodes with a lower carbon intensity or better power efficiency parameter than the first cluster of computing nodes, such as due to use of a renewable power source or carbon offset. The machine-readable instructions can migrate a workload of the workloads to the second cluster of computing nodes.

FIG. 5 is a block diagram of a system 500 according to some examples of the present disclosure. The system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The system 500 includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include carbon and metric information reception instructions 506 to receive, for clusters of computing nodes, carbon emission information and metric data for workloads executed in the clusters of computing nodes. The workloads may be executed at virtual schedulable entities running in the computing nodes of the clusters.

The machine-readable instructions in the storage medium 504 include routing policy adjustment instructions 508 to, based on the carbon emission information and power consumption information derived from the metric data of the workloads, adjust a routing policy for routing of traffic associated with the workloads. The routing policy adjustment instructions 508 may be part of the traffic routing controller 112 of FIG. 1.

The machine-readable instructions in the storage medium 504 include adjusted routing policy application instructions 510 to send the adjusted routing policy to a traffic router of the cluster of computing nodes, the traffic router to use the adjusted routing policy in routing traffic for the workloads in the cluster of computing nodes.

The machine-readable instructions in the storage medium 504 include workload placement instructions 512 to, based on the adjusted routing policy, place a workload on a computing node selected from the computing nodes in the clusters of computing nodes. The workload placement instructions 512 may be part of the workload scheduler 114 of FIG. 1.

In some examples, the power consumption information is (1) included in power consumption metrics collected by power consumption sensors, or (2) derived from resource utilization metrics collected by resource utilization sensors.

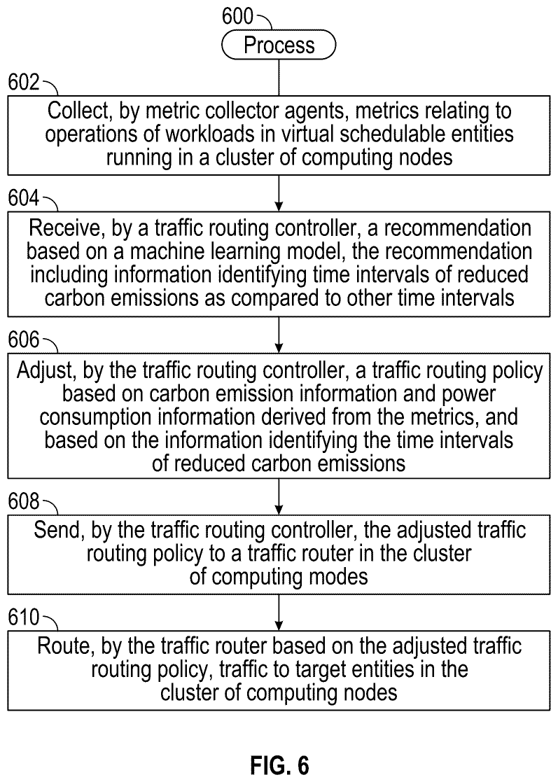

FIG. 6 is a flow diagram of a process 600 according to some examples. The process 600 may be performed by one or more computers.

The process 600 includes collecting (at 602), by metric collector agents, metrics relating to operations of workloads in virtual schedulable entities running in a cluster of computing nodes. The metric collector agents may include the MCAs 120, 122, 126, 130, 160, and 162 of FIG. 1, for example.

The process 600 includes receiving (at 604), by a traffic routing controller, a recommendation based on a machine learning model, the recommendation including information identifying time intervals of reduced carbon emissions as compared to other time intervals. The recommendation can be provided by the recommendation engine 116 of FIG. 1, for example.

The process 600 includes adjusting (at 606), by the traffic routing controller, a traffic routing policy based on carbon emission information and power consumption information derived from the metrics, and based on the information identifying the time intervals of reduced carbon emissions.

The process 600 includes sending (at 608), by the traffic routing controller, the adjusted traffic routing policy to a traffic router in the cluster of computing nodes. The traffic router may be the traffic router 140 or 142 in FIG. 1, for example.

The process 600 includes routing (at 610), by the traffic router based on the adjusted traffic routing policy, traffic to target entities in the cluster of computing nodes. In some examples, the carbon emission information comprises a carbon intensity and a carbon offset.

As used here, a “memory” can be implemented with one or more memory devices, such as a dynamic random access memory (DRAM) device, a static random access memory (SRAM) device, an erasable and programmable read-only memory (EPROM) device, an electrically erasable and programmable read-only memory (EEPROM) device, or a flash memory device.

As used here, an “engine” or a “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” or a “controller” can refer to a combination of one or more hardware processing circuits and machine-readable instructions (software and/or firmware) executable on the one or more hardware processing circuits.

A storage medium (e.g., 400 in FIG. 4 or 504 in FIG. 5) can include any or some combination of the following: a semiconductor memory device such as a DRAM or SRAM device, an EPROM device, an EEPROM device, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
execute workloads at virtual schedulable entities across a cluster of computing nodes;
receive, for the cluster, carbon emission information and metric data for the workloads;
based on the carbon emission information and power consumption information derived from the metric data of the workloads, adjust a routing policy for routing of traffic associated with the workloads; and
send the adjusted routing policy to a traffic router of the cluster of computing nodes, the traffic router to use the adjusted routing policy in routing traffic for the workloads in the cluster of computing nodes.

2. The non-transitory machine-readable storage medium of claim 1, wherein the traffic comprises one or more of a request for a workload or data of the workload.

3. The non-transitory machine-readable storage medium of claim 1, wherein the adjusted routing policy controls routing of the traffic to one or more of a container, a pod, a computing node, or a computing environment.

4. The non-transitory machine-readable storage medium of claim 1, wherein the cluster of computing nodes is a first cluster of computing nodes, and the adjusted routing policy controls routing of further traffic between the first cluster of computing nodes and a second cluster of computing nodes based on the carbon emission information and the power consumption information.

5. The non-transitory machine-readable storage medium of claim 1, wherein the metric data relates to one or more of processor utilization, memory utilization, or an amount of network data communication, and the power consumption information is based on the metric data relating to one or more of the processor utilization, the memory utilization, or the amount of network data communication.

6. The non-transitory machine-readable storage medium of claim 1, wherein the carbon emission information comprises a carbon intensity, and the instructions upon execution cause the system to:
compute a carbon emission of a workload of the workloads based on combining the carbon intensity and the power consumption information for the workload.

7. The non-transitory machine-readable storage medium of claim 5, wherein the cluster of computing nodes is deployed across multiple sites, and the carbon emission information comprises a first carbon intensity for a first site of the multiple sites, and a second carbon intensity for a second site of the multiple sites, and the instructions upon execution cause the system to:
compute a first carbon emission for the first site based on combining the first carbon intensity and the power consumption information; and
compute a second carbon emission for the second site based on combining the second carbon intensity and the power consumption information,
wherein the adjusting of the routing policy is based on the first carbon emission and the second carbon emission.

8. The non-transitory machine-readable storage medium of claim 1, wherein the instructions upon execution cause the system to:
place a workload in the cluster of computing nodes based on the adjusted routing policy.

9. The non-transitory machine-readable storage medium of claim 8, wherein the placing of the workload in the cluster of computing nodes is further based on resource utilization metrics of the computing nodes in the cluster of computing nodes.

10. The non-transitory machine-readable storage medium of claim 1, wherein the instructions upon execution cause the system to:
predict, based on historical information of carbon emissions and power consumption in the cluster of computing nodes, a first time interval with a lower carbon emission than a second time interval; and
adjust the routing policy further based on the predicted first time interval.

11. The non-transitory machine-readable storage medium of claim 10, wherein the predicting is performed by a machine learning model based on the historical information of carbon emissions and power consumption.

12. The non-transitory machine-readable storage medium of claim 1, wherein the traffic router comprises one of a network switch, an ingress controller, or a service mesh.

13. The non-transitory machine-readable storage medium of claim 1, wherein the instructions upon execution cause the system to:
receive a power efficiency parameter for the cluster,
wherein the adjusting of the routing policy is further based on the power efficiency parameter.

14. The non-transitory machine-readable storage medium of claim 1, wherein the cluster of computing nodes is a first cluster of computing nodes, and the instructions upon execution cause the system to:
identify a second cluster of computing nodes with a lower carbon intensity or better power efficiency parameter than the first cluster of computing nodes; and
migrate a workload of the workloads to the second cluster of computing nodes.

15. A system comprising:
a hardware processor; and
a non-transitory storage medium storing instructions executable on the hardware processor to:
receive, for clusters of computing nodes, carbon emission information and metric data for workloads executed in the clusters of computing nodes;
based on the carbon emission information and power consumption information derived from the metric data of the workloads, adjust a routing policy for routing of traffic associated with the workloads;
send the adjusted routing policy to a traffic router of at least one cluster of the clusters of computing nodes, the traffic router to use the adjusted routing policy in routing traffic for the workloads in the at least one cluster; and
based on the adjusted routing policy, place a workload on a computing node selected from the computing nodes in the clusters of computing nodes.

16. The system of claim 15, wherein the power consumption information is:
included in power consumption metrics collected by power consumption sensors, or
derived from resource utilization metrics collected by resource utilization sensors.

17. The system of claim 15, wherein the instructions are executable on the hardware processor to:
predict, using a machine learning model, time intervals of reduced carbon emissions,
wherein the adjusting of the routing policy is further based on the predicted time intervals of reduced carbon emissions.

18. The system of claim 15, wherein the instructions are executable on the hardware processor to:
receive power efficiency parameters for the clusters of computing nodes,
wherein the adjusting of the routing policy is further based on the power efficiency parameters.

19. A method comprising:
collecting, by metric collector agents, metrics relating to operations of workloads in virtual schedulable entities running in a cluster of computing nodes;
receiving, by a traffic routing controller, a recommendation based on a machine learning model, the recommendation comprising information identifying time intervals of reduced carbon emissions as compared to other time intervals;
adjusting, by the traffic routing controller, a traffic routing policy based on carbon emission information and power consumption information derived from the metrics, and based on the information identifying the time intervals of reduced carbon emissions;
sending, by the traffic routing controller, the adjusted traffic routing policy to a traffic router in the cluster of computing nodes; and
routing, by the traffic router based on the adjusted traffic routing policy, traffic to target entities in the cluster of computing nodes.

20. The method of claim 19, wherein the carbon emission information comprises a carbon intensity and a carbon offset.
